(19) United States
(12) Patent Application Publication
(10) Pub. No.: US 2024/0025433 A1
(43) Pub. Date: Jan. 25, 2024

(54) DRIVER ASSISTANCE SYSTEM FOR VEHICLE

(71) Applicant: TOYOTA JIDOSHA KABUSHIKI KAISHA, Aichi-ken (JP)

(72) Inventors: Yudai SADAKUNI, Toyota-shi (JP); Masato ENDO, Nagoya-shi (JP); Yuko HIRATSUKA, Toyota-shi (JP); Akihito NAKAMURA, Toyota-shi (JP); Shuhei MANABE, Toyota-shi (JP)

(21) Appl. No.: 18/332,754

(22) Filed: Jun. 12, 2023

(30) Foreign Application Priority Data
Jul. 25, 2022 (JP) 2022-117717

(51) Int. Cl. B60W 50/08; G07C 5/08; B60R 1/23; B60W 50/14

(52) U.S. Cl. CPC B60W 50/087; G07C 5/0825; B60R 1/23; B60W 50/14; B60W 2050/146; B60W 2540/10; B60W 2540/12; B60W 2540/18; B60W 2420/42; B60W 2710/18; B60W 2720/106

(57) ABSTRACT

A driver information registration unit can register driver information of a vehicle. A personalization data storage unit (registered driver data storage unit) stores a driving history for each registered driver who is a driver registered in the driver information registration unit. An additional function extraction unit extracts an additional assistance function that is a driver assistance function that can be newly added for each registered driver based on the driving history. A display control unit can output a proposal image that proposes the registered driver an acquisition of the additional assistance function to a center panel display (display unit).

### CROSS-REFERENCE TO RELATED APPLICATION

This application claims priority to Japanese Patent Application No. 2022-117717 filed on Jul. 25, 2022 incorporated herein by reference in its entirety.

### BACKGROUND

### 1. Technical Field

The present specification discloses a driver assistance system for a vehicle.

### 2. Description of Related Art

Conventionally, an information providing system using a driving history of a vehicle has been known. For example, in WO 2021/186636, fuel consumption is calculated based on the travel history of the vehicle. The system determines whether it is possible to reach the planned destination in the most recent drive plan based on the fuel consumption and the current remaining amount of gasoline. When the system determines that the vehicle cannot reach the planned destination with the current remaining amount of gasoline, the system proposes refueling with a gasoline delivery service during time when the user is not using the vehicle.

### SUMMARY

In addition to the driver assistance function installed in the vehicle at the time of purchase, there are also functions that can be additionally used after the purchase. This specification discloses a driver assistance system for a vehicle capable of appropriately proposing addition of functions of driver assistance items.

A driver assistance system for a vehicle disclosed in the present specification includes a registration unit, a registered driver data storage unit, an additional function extraction unit, and a display control unit. The registration unit is able to register driver information of the vehicle. The registered driver data storage unit stores a driving history for each of registered drivers who are drivers registered in the registration unit. The additional function extraction unit extracts an additional assistance function for each of the registered drivers based on the driving history, the additional assistance function being a driver assistance function that is newly addable. The display control unit is able to output a proposal image that proposes the registered driver an acquisition of the additional assistance function to a display unit.

According to the above configuration, it is possible to propose the registered driver the additional assistance function corresponding to the driving history of the registered driver.

Also, in the above configuration, the additional function extraction unit may be able to transmit, to the display control unit, information on whether a free trial of the additional assistance function is available in addition to information on the additional assistance function.

According to the above configuration, the free trial of the additional assistance function can lead to the purchase of the additional assistance function.

Also, in the above configuration, the driver assistance system may include a driving diagnostic unit that performs driving diagnosis based on the driving history. In this case, the display control unit causes the display unit to display a driving diagnostic image together with the proposal image.

According to the above configuration, since the basis for proposing the additional assistance function is presented, the registered driver can feel a sense of satisfaction upon purchase.

Also, in the above configuration, the registered driver data storage unit may store the number of times of a predetermined noted action from among driver actions for each of the registered drivers. In this case, the additional function extraction unit extracts the additional assistance function corresponding to the noted action of which number of times exceeds a predetermined threshold value.

According to the above configuration, installation of the additional assistance function makes it possible to suppress abrupt vehicle movements when the noted action of the registered driver, such as sharp steering, occurs.

Also, in the above configuration, the vehicle may be provided with an exterior camera that captures an image outside the vehicle, and a captured image storage unit that stores a captured moving image captured by the exterior camera. In this case, the display control unit causes the display unit to display the captured moving image together with the proposal image. The captured moving image includes a moving image when the noted action corresponding to the additional assistance function proposed by the proposal image is performed.

According to the above configuration, the moving image when the noted action that is the basis for proposing the additional assistance function is operated is shown together with the proposal image, whereby it is possible to appeal to the registered driver the importance of the acquisition of the additional assistance function.

Also, in the above configuration, when the driver assistance function is executed, an acceleration, a turning attitude, and a braking amount that do not correspond to operation amounts of an accelerator pedal, a steering wheel, and a brake pedal are output from the vehicle. The noted action includes sudden acceleration, sudden braking, and sharp steering. Further, the driver assistance system includes a noted action determination unit. The noted action determination unit determines whether the sudden acceleration is performed based on the operation amount of the accelerator pedal. Further, the noted action determination unit determines whether the sudden braking is performed based on the operation amount of the brake pedal. Furthermore, the noted action determination unit determines whether the sharp steering is performed based on the operation amount of the steering wheel.

According to the above configuration, whether the sudden acceleration, the sudden reverse, the sudden braking, and the sharp steering are performed is determined based on the actual operation amounts performed by the driver with respect to the vehicle. Therefore, even when the driver assistance function is executed and thus the sudden acceleration, the sudden turning, and the sudden braking of the vehicle can be avoided, it is possible to detect the noted action of the driver.

Also, in the above configuration, a store that is able to perform service work on the vehicle may be registered in the registered driver data storage unit. In this case, the driver assistance system includes an inventory confirmation unit. The inventory confirmation unit confirms whether a device for executing the additional assistance function is in stock at the registered store. When the device is not in stock at the registered store, the display control unit hides the proposal image.

According to the above configuration, mismatching between supply and demand, such as when the driver visits the registered store to install the proposed additional assistance function but and there is no inventory, can be suppressed.

Also, in the above configuration, the driver assistance system may include a service work setting unit. The service work setting unit extracts a workable date and time when service work of the additional assistance function is able to be performed at the registered store when the device is in stock at the store. In the proposal image, when an input operation for acquiring the additional assistance function is received from the registered driver, the display control unit causes the display unit to display the workable date and time.

According to the above configuration, a reservation for the installation work when the additional assistance function is proposed can become possible, and this makes it possible to quickly install the additional assistance function in the vehicle.

According to the driver assistance system for a vehicle of the present specification, it is possible to appropriately propose addition of functions for driver assistance items to the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram exemplifying an overall configuration of a driver assistance system for a vehicle according to the present embodiment;

FIG. 2 is a diagram showing a hardware configuration of the vehicle;

FIG. 3 is a diagram exemplifying various sensors mounted in a front portion of the vehicle;

FIG. 4 is a diagram exemplifying a front portion of a vehicle cabin;

FIG. 5 is a diagram exemplifying a navigation image displayed on a center display;

FIG. 6 is a diagram exemplifying functional blocks of the ADAS-ECU and the AV-ECU;

FIG. 7 is a diagram exemplifying a vehicle data table;

FIG. 8 is a diagram exemplifying a driver assistance function recording table;

FIG. 9 is a diagram exemplifying a noted action table;

FIG. 10 is a diagram exemplifying functional blocks of an OTA center and a registered store terminal;

FIG. 11 is a diagram exemplifying a driver assistance function recording table;

FIG. 12 is a diagram exemplifying a driving diagnostic flow in the OTA center server;

FIG. 13 is a diagram exemplifying a driving diagnostic image display flow (first half) in the vehicle;

FIG. 14 is a diagram exemplifying the driving diagnostic image display flow (second half) in the vehicle; and

FIG. 15 is a diagram showing an example in which a driving diagnostic image, a proposal image, and an exterior camera image are displayed on the center display.

### DETAILED DESCRIPTION OF EMBODIMENTS

### Overall Configuration

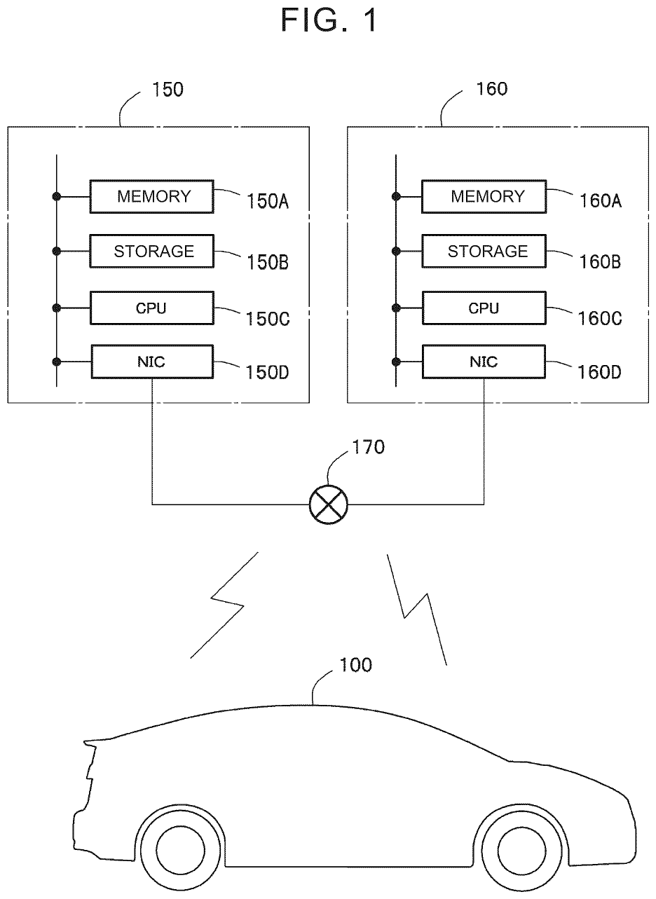

FIG. 1 exemplifies an overall configuration of a driver assistance system for a vehicle according to the present embodiment. This system includes a vehicle 100, an OTA center server 150, and a registered store terminal 160.

As will be described below, the OTA center server 150 can transmit update programs for software and firmware installed in various ECUs of the vehicle 100 by wireless communication (over-the-air).

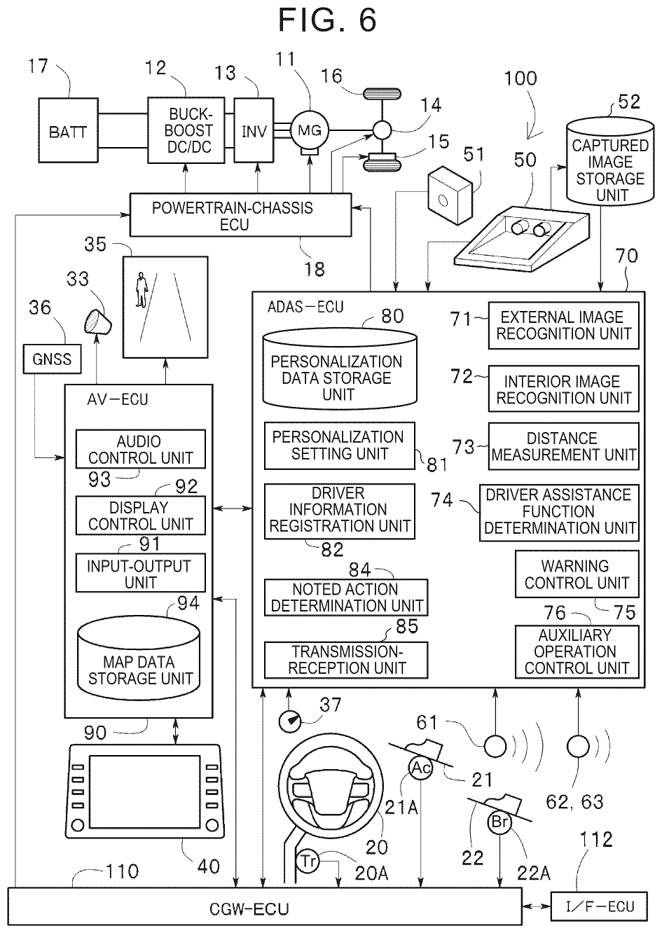

The registered store terminal 160 is a computer installed in a store registered in a personalization data storage unit 80 (see FIG. 6) of the vehicle 100 and capable of communicating with the vehicle 100.

With reference to FIG. 1, in the driver assistance system for a vehicle according to the present embodiment, a driver assistance function that can be added to the vehicle 100 is proposed. Upon this proposal, the driver information of the vehicle 100 is registered. Furthermore, the driving history is recorded for each registered driver. Further, based on the driving record, an additional assistance function that is a driver assistance function that can be newly added is proposed for each registered driver.

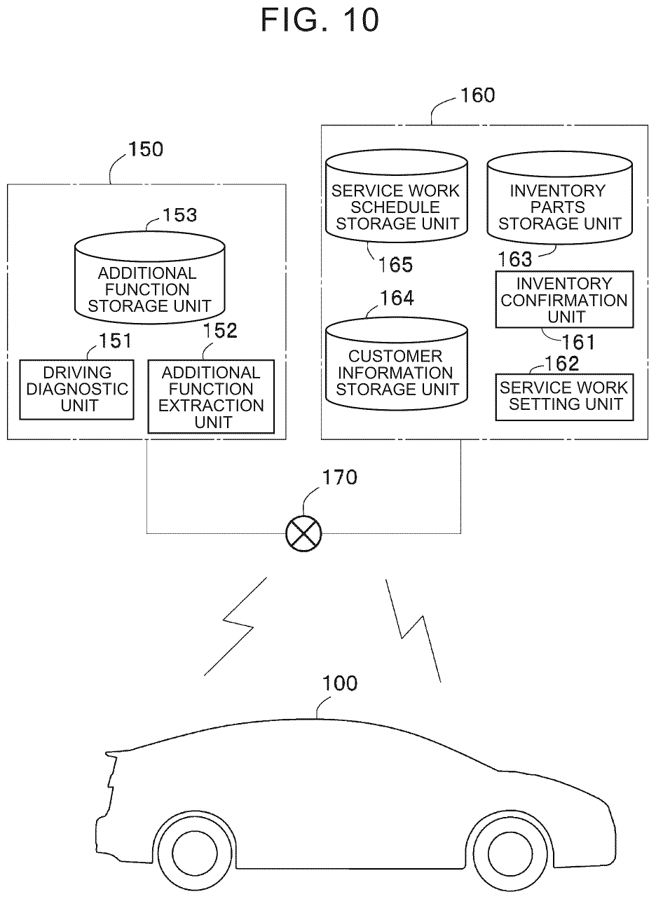

When installation of the additional assistance function does not involve service work on the vehicle 100, such as software update, an update program is transmitted from the OTA center server 150 to the vehicle 100. On the other hand, when the installation of the additional assistance function involves work on the vehicle 100, such as setting of an additional device, an inventory confirmation unit 161 (see FIG. 10) of the registered store terminal 160 confirms whether the additional device is in stock.

When the additional device is in stock at the registered store, a purchase button image 43A is displayed in a proposal image 43 on the center display 40 (see FIG. 15). When the registered driver performs an input operation such as tapping on the purchase button image 43A, a service work setting unit 162 extracts a workable date and time at the registered store and transmits the workable date and time to the vehicle 100. In addition, the center display 40 displays the workable date and time. The registered driver selects a convenient date and time from a plurality of workable dates and times. The additional assistance function is installed in the vehicle 100 by the above processes.

### Vehicle

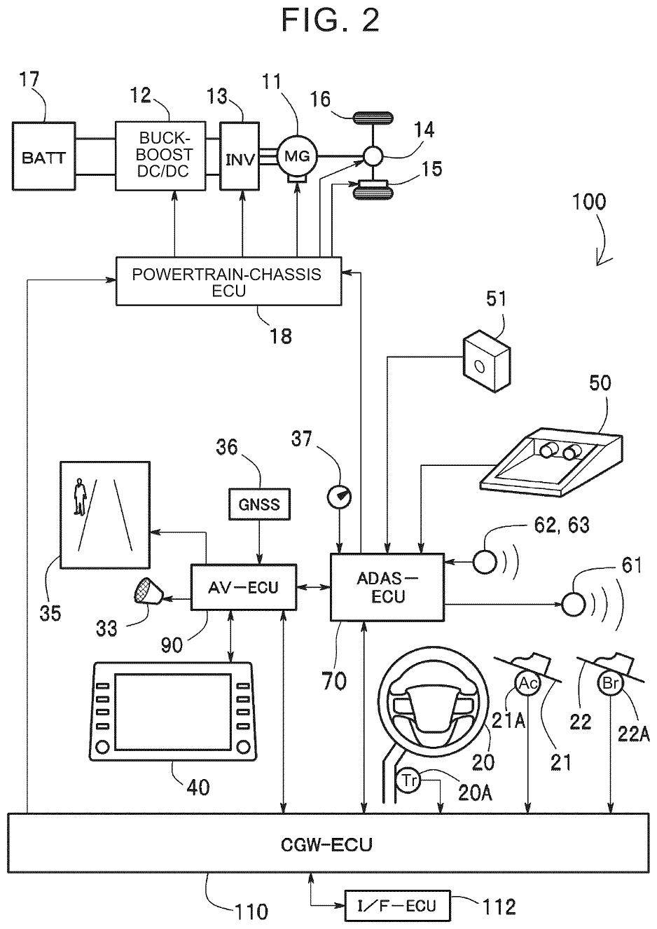

FIG. 2 exemplifies a hardware configuration of the vehicle 100. Note that FIG. 2 mainly exemplifies devices related to the driver assistance function of the vehicle 100, and the illustration of devices that are less relevant to the above function is omitted as appropriate.

The vehicle 100 may be, for example, a battery electric vehicle (BEV) that includes a rotary electric machine 11 as a drive source. Further, the vehicle 100 may be a hybrid electric vehicle (HEV) or a plug-in hybrid electric vehicle (PHEV).

### Drivetrain Devices

For example, the vehicle 100 includes a battery 17, a step up-down DC/DC converter 12, an inverter 13, and the rotary electric machine 11 as drivetrain high-voltage circuits. The direct-current (DC) power output from the battery 17 is, for example, stepped up by the step up-down DC/DC converter 12 and further converted into alternating current (AC) power by the inverter 13. The rotary electric machine 11 is driven by supplying the converted AC power to the rotary electric machine 11. This driving force is transmitted to drive wheels 16 via a steering mechanism 14. A brake mechanism 15 is provided for each drive wheel 16.

Further, the vehicle 100 is also provided with a steering wheel 20, an accelerator pedal 21, and a brake pedal 22 as mechanisms for manual operation. Further, the vehicle 100 is provided with a torque sensor 20A that detects an operation amount of the steering wheel 20. Still further, the vehicle 100 is provided with an accelerator position sensor 21A that detects the operation amount (depression amount) of the accelerator pedal 21 and a brake position sensor 22A that detects the operation amount (depression amount) of the brake pedal 22.

The operation amounts detected by the torque sensor 20A, the accelerator position sensor 21A, and the brake position sensor 22A are transmitted as electrical signals from the sensors 20A to 22A to a central gateway ECU 110 (hereinafter referred to as a CGW-ECU as appropriate). In response to the above, the CGW-ECU 110 transmits a drive command, a braking command, and a steering command to a powertrain-chassis ECU 18.

Further, the powertrain-chassis ECU 18 transmits a switching signal to the inverter 13 in accordance with the drive commands. The powertrain-chassis ECU 18 also transmits a drive signal to the motor of a brake mechanism 15 in accordance with the braking command. Further, the powertrain-chassis ECU 18 transmits drive signals to a steering motor of the steering mechanism 14 in response to the steering command.

Further, when the driver assistance function is executed, an auxiliary operation command is transmitted from the ADAS-ECU 70 to the powertrain-chassis ECU 18. For example, this auxiliary operation command has priority over the drive command, the braking command, and the steering command from the CGW-ECU 110. Details of the driver assistance function will be described later.

### Sensors

FIG. 2 exemplifies sensors for enabling the driver assistance functions for the vehicle 100 to be executed. The vehicle 100 includes an exterior camera unit 50, a LiDAR sensor 61, and radar sensors 62, 63 as sensors for grasping the situation outside the vehicle.

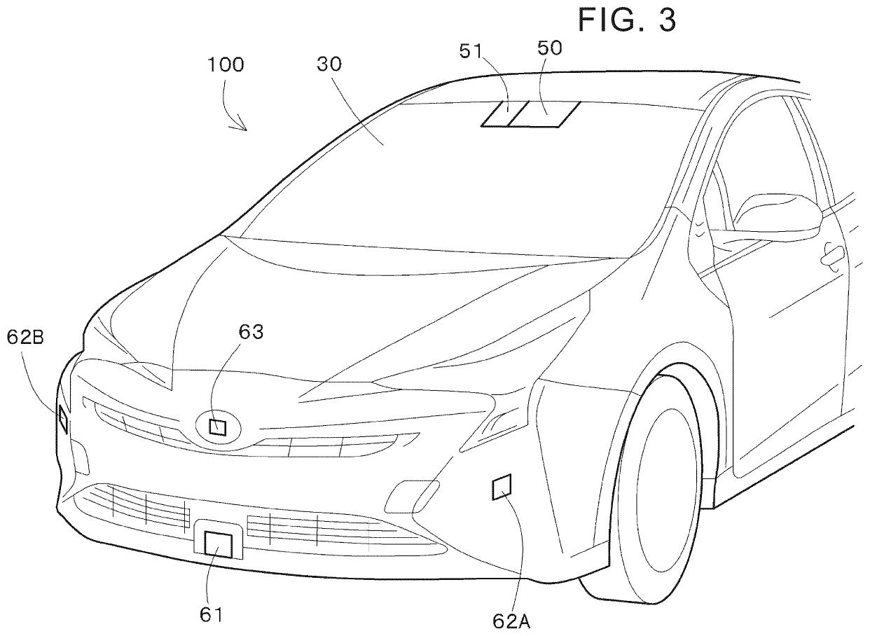

FIG. 3 illustrates the front portion of the vehicle 100. A front center radar sensor 63 is provided on a front surface portion of the vehicle 100, for example, on the rear side of an emblem in the central portion in the vehicle width direction. Front side radar sensors 62A, 62B are provided on respective sides of the front surface of the vehicle 100. Both of the radar sensors are composed of millimeter wave radars, for example.

Furthermore, the LiDAR sensor 61 is provided on the front surface of the vehicle 100, for example, in the central portion in the vehicle width direction, below the license plate mounting position. The LiDAR (Light Detection and Ranging) sensor 61 planarly scans with laser light (for example, infrared rays) to measure the distance to surrounding objects. The LiDAR sensor 61 is, for example, a solid-state unit. Three dimensional point cloud data in front of the vehicle 100 can be obtained by the LiDAR sensor 61 planarly scanning forward of the vehicle 100 with a laser beam.

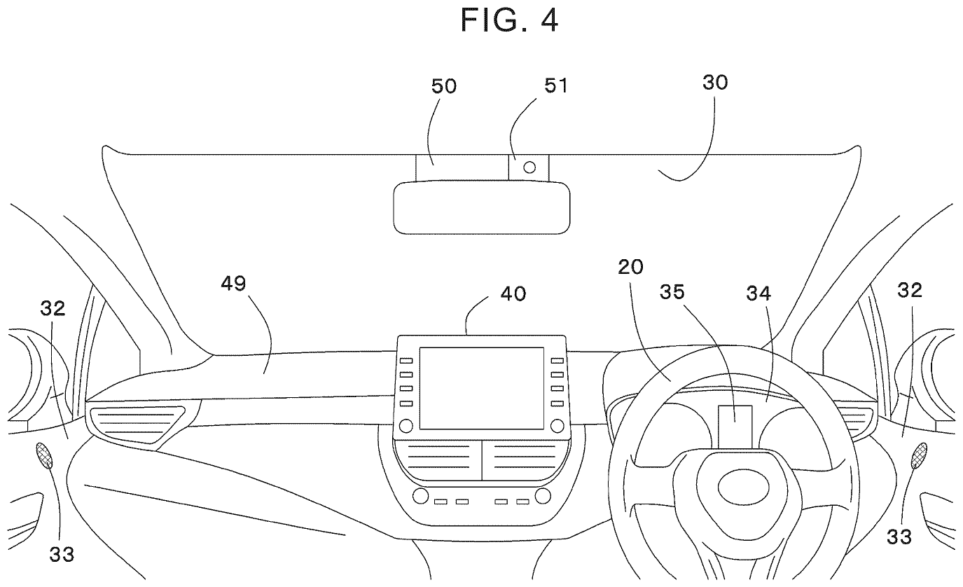

With reference to FIGS. 3 and 4, the exterior camera unit 50 and an interior camera 51 are provided on the rear surface of a windshield glass 30, that is, a surface exposed to a vehicle cabin. The exterior camera unit 50 and the interior camera 51 are provided, for example, in the center portion of the windshield glass 30 in the vehicle width direction and in an upper portion of the windshield glass 30.

The exterior camera unit 50 is, for example, a stereo camera unit composed of two cameras, and is capable of imaging the outside of the vehicle, more specifically, imaging forward of the vehicle through the windshield glass 30. The interior camera 51 is, for example, a monocular camera, and is capable of imaging, for example, the driver's face in the vehicle cabin.

The exterior camera unit 50 and the interior camera 51 are each capable of capturing moving images. The captured moving image data is stored in a captured image storage unit 52 (see FIG. 6) in a state of being associated with the date and time when the image is captured.

With reference to FIG. 2, a self-position estimator 36 is, for example, a receiver of a global navigation positioning satellite system. The self-position estimator 36 is connected to an AV-ECU 90.

A clock 37 is connected to the ADAS-ECU 70. As will be described later, the driver assistance function determination unit 74 (see FIG. 6) of the ADAS-ECU 70 acquires the date and time when the driver assistance function is executed from the clock 37 and stores the date and time in the personalization data storage unit 80. Further, a noted action determination unit 84 acquires the date and time at which the noted action of the driver occurs from the clock 37 and stores the date and time in the personalization data storage unit 80. From this aspect, the personalization data storage unit 80 is also called a registered driver data storage unit.

### Audiovisual Devices

FIG. 4 exemplifies the front portion of the vehicle cabin. As video devices, an instrument panel 49 is provided with the center display 40 and a meter display 35.

The center display 40 is, for example, a touch panel display in which an input unit and a display unit are integrated. The center display 40 is installed, for example, on the ceiling surface of the instrument panel 49 and at the center in the vehicle width direction.

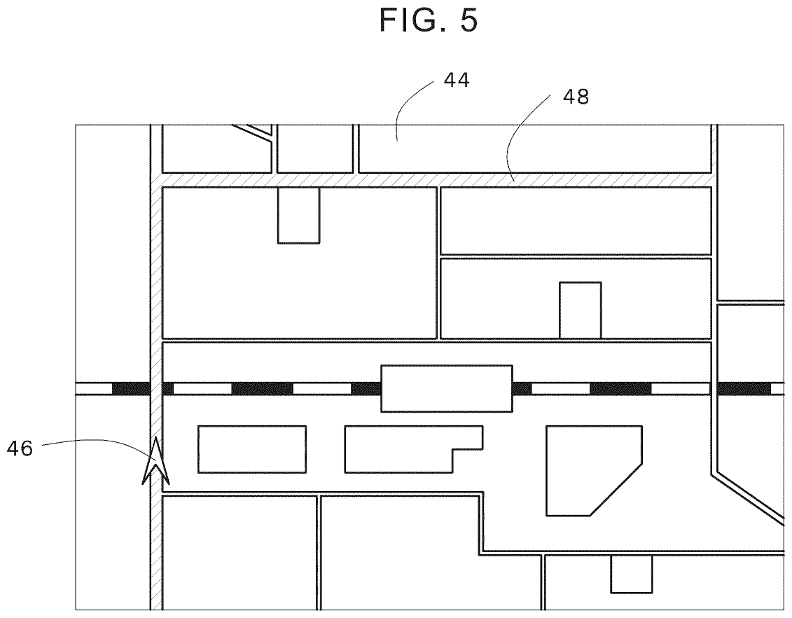

The center display 40 displays various types of information of the vehicle 100. For example, a navigation image 44 as exemplified in FIG. 5 is displayed on the center display 40. Further, a driving diagnostic image 41, the proposal image 43, and an exterior camera moving image 45 as exemplified in FIG. 15 are displayed on the center display 40.

Further, for example, a setting image is displayed on the center display 40 at the time of personalization setting of the driver assistance function that will be described later. In this setting image, it is possible to select whether to enable a plurality of driver assistance functions, and the set values of the enabled driver assistance functions.

With reference to FIG. 4, the meter display 35 is provided within an instrument cluster 34. The meter display 35 is disposed in front of the steering wheel 20, for example. For example, the meter display 35 displays a warning message in the driver assistance function.

Speakers 33 are provided in the vehicle cabin as an audio device. For example, the speakers 33 are provided in upper and forward portions of paired front doors 32, 32, respectively. Each speaker 33 is, for example, a so-called tweeter that outputs high-pitched sounds. Also, an output surface of each speaker 33 is directed toward the driver or an occupant seated in the passenger seat. As will be described later, a warning sound for the driver assistance function is output from the speakers 33.

### ECU

As exemplified in FIG. 2, the vehicle 100 is provided with a plurality of electronic control units (ECUs). These electronic control units are provided for each function of the vehicle 100, for example. For example, the vehicle 100 includes the powertrain-chassis ECU 18, the ADAS-ECU 70, the AV-ECU 90 and an I/F-ECU 112.

Further, the vehicle 100 is provided with a central gateway ECU 110 (CGW-ECU) as a master ECU that governs these functional ECUs. The CGW-ECU 110 governs each functional ECU, for example, when cooperative control in which multiple functional ECUs cooperate to execute one function is executed.

The powertrain-chassis ECU 18, the ADAS-ECU 70, the AV-ECU 90, and the I/F-ECU 112 can communicate with each other via the CGW-ECU 110. Each ECU is connected by a signal line complying with the controller area network (CAN) standard, for example.

The powertrain-chassis ECU 18 controls the rotary electric machine 11, the steering mechanism 14, and the brake mechanism 15. Further, the I/F-ECU 112 is an ECU serving as an interface for receiving signals from external devices such as the OTA center server 150 (see FIG. 1) and the registered store terminal 160.

The ADAS-ECU 70 is an ECU for ADAS that denotes the advanced driver-assistance system. The ADAS-ECU 70 is connected via signals to the exterior camera unit the interior camera 51, the LiDAR sensor 61, and the radar sensors 62, 63 that are sensors for grasping conditions outside the vehicle.

The AV-ECU 90 executes display control and audio control of the speakers 33, the meter display 35, and the center display 40. The input operation information to the center display 40 that is a touch panel is transmitted from the AV-ECU 90 to the ADAS-ECU 70 and the CGW-ECU 110.

Each of the functional ECUs and the CGW-ECU 110 described above is composed of an electronic device (computer) similar to the OTA center server 150 and the registered store terminal 160 exemplified in FIG. 1. In other words, the ECUs each include a memory, a storage device, a central processing unit (CPU), and a network interface card (NIC).

The NIC is an interface device for connecting with other devices. The CPU executes various controls and calculations in accordance with given programs. The memory is a volatile storage device of which stored information is erased, for example, when the power supply is interrupted. For example, the memory is composed of dynamic random access memory (DRAM). The storage device is a non-volatile storage device that can retain stored data without power. The storage device is composed of, for example, a solid state drive (SSD).

### Functional Block of AV-ECU

A CPU executes a program stored in a storage device of the AV-ECU 90 to configure the functional blocks in the AV-ECU 90 as exemplified in FIG. 6. That is, the AV-ECU 90 includes an input-output unit 91, a display control unit 92, an audio control unit 93, and a map data storage unit 94.

The program may be stored in a non-transitory computer-readable storage medium such as a digital versatile disc (DVD), instead of storing the program in the storage device, and the CPU may read and execute the program. Various functional blocks exemplified in FIG. 6 are configured in the AV-ECU 90 by such means as well.

The map data storage unit 94 stores map data associated with latitude and longitude information. The audio control unit 93 outputs a warning sound from the speakers 33 when a warning command is received from the warning control unit 75 of the ADAS-ECU 70.

The input-output unit 91 receives input signals from peripheral devices such as the ADAS-ECU 70. Further, the input-output unit 91 also receives input operation signals from the center display 40 that is a touch panel and transmits the signals to the peripheral devices such as the ADAS-ECU 70.

The display control unit 92 controls display images of the meter display 35 and the center display 40. For example, upon receipt of the warning command from the warning control unit 75 of the ADAS-ECU 70, the display control unit 92 causes the meter display 35 to display a warning image (image of a pedestrian, etc.).

While the vehicle 100 is traveling, the display control unit 92 causes the center display 40 to display the navigation image 44 as exemplified in FIG. 5. The display control unit 92 determines a map image area to be displayed on the center display 40 based on the self-position information (latitude information and longitude information) acquired from the self-position estimator 36. Further, the display control unit 92 also superimposes a host vehicle mark 46 and a guided route 48 on the map image area.

Further, while the vehicle 100 is stopped, for example, when the shift lever is set to the P range, the display control unit 92 causes the center display 40 to display a driving diagnostic image 41 as exemplified in FIG. 15. Furthermore, the display control unit 92 displays the proposal image 43, the exterior camera moving image 45, and a noted action explanation image 47 so as to be arranged in the driving diagnostic image 41. Details of the images will be described later.

### Functional Block of ADAS-ECU

The CPU of the ADAS-ECU 70 executes a program stored in the storage device, whereby the functional blocks exemplified in FIG. 6 are configured in the ADAS-ECU 70. That is, the ADAS-ECU 70 includes an exterior image recognition unit 71, an interior image recognition unit 72, a distance measurement unit 73, a driver assistance function determination unit 74, a warning control unit 75, and an auxiliary operation control unit 76. The ADAS-ECU 70 further includes the personalization data storage unit 80, a personalization setting unit 81, a driver information registration unit 82, the noted action determination unit 84, and a transmission-reception unit 85.

The program may be stored in a non-transitory computer-readable storage medium such as a digital versatile disc (DVD), instead of storing the program in the storage device, and the CPU may read and execute the program. Various functional blocks exemplified in FIG. 6 are configured in the ADAS-ECU 70 by such means as well.

The exterior image recognition unit 71 recognizes an image area of an object outside the vehicle from the image captured by the exterior camera unit 50. For example, the exterior image recognition unit 71 is implemented with a convolutional neural network (CNN) capable of executing the single shot multibox detector (SSD) using supervised learning as an image recognition algorithm. Attributes of various objects (vehicles, pedestrians, road signs, structures, etc.) included in the images captured by the exterior camera unit 50 are recognized through such image recognition.

Further, the distance measurement unit 73 acquires captured image data that has been subjected to image recognition from the exterior image recognition unit 71. Further, the distance measurement unit 73 also acquires three-dimensional point cloud data of distance measurement information from the LiDAR sensor 61. The distance measurement unit 73 obtains what kind of attributes an object has and how far the object is from the host vehicle by combining the three-dimensional point cloud data and the captured image data.

The interior image recognition unit 72 recognizes the face of the driver from the image captured by the interior camera 51 using the image recognition algorithm described above. The personalization setting unit 81 determines whether the driver corresponds to one of the registered drivers stored in the personalization data storage unit 80 based on a face recognition result. Further, the noted action determination unit 84 determines whether the driver is performing a noted action, such as looking aside, based on the face recognition result.

The driver assistance function determination unit 74 determines whether to execute the driver assistance function with respect to the warning control unit 75 and the auxiliary operation control unit 76 based on object information (the attributes and the distance from the host vehicle) around the host vehicle from the distance measurement unit 73.

The driver assistance functions can be classified into main categories of a warning function and an auxiliary operation function. For example, a warning is issued as a step before the auxiliary operation is executed. For example, when a pedestrian in front comes close in a predetermined first threshold distance, the driver assistance function determination unit 74 transmits a warning command to the warning control unit 75. When the distance to the pedestrian further decreases and the vehicle 100 approaches the pedestrian in a predetermined second threshold distance, the driver assistance function determination unit 74 outputs an execution command of the auxiliary operation function to the auxiliary operation control unit 76. In response to this, the auxiliary operation control unit 76 operates the steering mechanism 14 via the powertrain-chassis ECU 18, for example, to move toward the side opposite to the pedestrian within the lane in which the vehicle is traveling.

The number of operations of the driver assistance function above is counted up. For example, the operations of the driver assistance function is counted up when the warning function is executed. FIG. 8 exemplifies the driver assistance function recording table. In this table, the number of operations of each driver assistance function is recorded for each registered driver based on the personalization function to be described later.

In addition, this table also records data on the date and time when and a location where the driver assistance function is activated. The driver assistance function determination unit 74 acquires date and time data from the clock 37 (see FIG. 6). Further, the driver assistance function determination unit 74 also acquires location data from the self-position estimator 36. For example, the names of the facility, intersection, etc. closest to the latitude and longitude of the vehicle 100 when the driver assistance function is activated are recorded in the driver assistance function recording table.

The warning control unit 75 outputs the warning command to the audio control unit 93 of the AV-ECU 90 when the execution command of the driver assistance function is received from the driver assistance function determination unit 74. The warning command includes, for example, identification number information of the warning sound. Further, the warning control unit 75 outputs the warning command to the display control unit 92 of the AV-ECU 90 when the above execution command is received from the driver assistance function determination unit 74. The warning command includes, for example, the identification number information of the warning image.

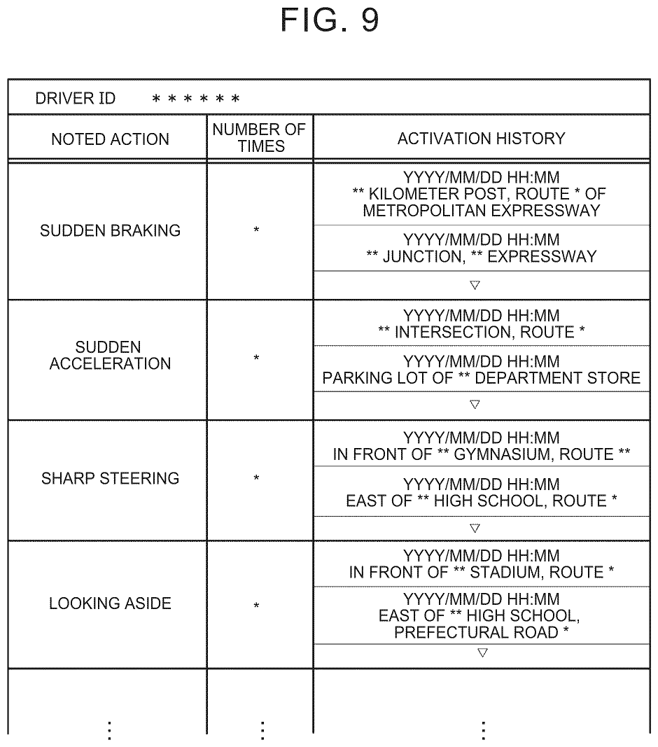

The noted action determination unit 84 determines whether a predetermined noted action among the driver actions has occurred in the vehicle 100. FIG. 9 exemplifies the noted action table. The noted action table is stored for each registered driver based on a personalization function to be described later. Noted action items are set in the noted action table.

The noted action refers to a driver action that increases the risk of a vehicle accident, and includes, for example, sudden braking, sudden acceleration, sharp steering, and looking aside. The sudden braking and the sudden acceleration denote states in which depressing accelerations of the brake pedal and the accelerator pedal exceed predetermined threshold values. The sharp steering refers to a state in which the angular acceleration when the steering wheel is turned exceeds a predetermined threshold value.

The noted action determination unit 84 determines whether noted actions of the sudden braking, sudden acceleration, and sharp steering occur based on the operation amounts detected by the brake position sensor 22A (see FIG. 6), the accelerator position sensor 21A, and the torque sensor 20A, respectively. Whether the driver looks aside can be determined from the captured image of the interior camera 51 as described above.

It is possible to determine with high accuracy whether the noted action occurs by determining whether there is a noted action based on the actual operation amounts detected by the brake position sensor 22A, the accelerator position sensor 21A, and the torque sensor 20A. For example, it is possible to determine with high accuracy whether the noted action occurs, as compared with determination based on images captured inside and outside the vehicle by the exterior camera unit 50, the interior camera 51, and the like.

For example, there may be case where, when the driver applies the sudden braking, that is, when the driver rapidly depresses the brake pedal 22, the driver assistance functions such as an anti-brake lock system (ABS) is activated, and thus a braking force corresponding to the depression amount of the brake pedal 22 cannot be obtained.

In other words, even when the driver depresses the brake pedal 22 rapidly, such braking may not result in sudden braking in terms of the vehicle behavior. As described above, there is a case where, when the driver assistance function intervenes on the operation line from the input as the operation amount to the output as the vehicle operation, the output and the input are out of balance. In other words, the vehicle 100 outputs acceleration, turning attitude, and braking amount that do not correspond to the operation amounts of the accelerator pedal 21, the steering wheel 20, and the brake pedal 22, by executing the driver assistance function. In many cases, the vehicle 100 outputs the acceleration, the turning attitude, and the braking amount that are suppressed as compared with the operation amounts of the accelerator pedal 21, the steering wheel 20, and the brake pedal 22, based on intervention of the driver assistance function.

Therefore, in the driver assistance system according to the present embodiment, for example, whether the noted action occurs is determined based on the actual operation amount of the driver, instead of the vehicle behavior, with respect to the noted action (sharp steering, sudden acceleration, sudden braking) related to the operation of the driver.

For example, when the brake pedal 22 is immediately deeply depressed, the driver assistance function may be activated and the sudden brake may not be applied to the vehicle 100. Even in such a case, the noted action determination unit 84 counts up the noted action “sudden braking” based on the operation amount of the brake pedal 22 detected by the brake position sensor 22A. It is possible to grasp the driving habits of each registered driver by performing such a determination.

Also, captured images are used for some of the noted actions. For example, the noted action determination unit 84 determines whether the driver looks aside based on the facial image recognition of the driver by the interior image recognition unit 72.

The noted action table also records the number of occurrences of each noted action item and its activation history. The activation history includes the date and time when and the location where the noted action occurs. The noted action determination unit 84 acquires the date and time data from the clock 37 (see FIG. 6). Further, the noted action determination unit 84 also acquires the location data from the self-position estimator 36. For example, the names of the facility, intersection, etc. closest to the latitude and longitude of the vehicle 100 when the noted action occurs are recorded in the driver assistance function recording table.

### Personalization

The vehicle 100 has a so-called personalization function that enables setting of the driver assistance function for each driver. In this personalization, it is possible to select whether to enable the setting of which function to enable among the driver assistance functions. Furthermore, in this personalization, set values for enabled driver assistance functions can be set for each driver.

For example, adaptive cruise control is enabled and lane tracing assist is disabled for a certain driver. Furthermore, the inter-vehicle distance is set to an arbitrary value (long, medium, or short) as a set value of the enabled adaptive cruise control.

The driver information registration unit 82 can register the driver information of the vehicle 100. For example, new driver registration and setting changes can be performed from the center display 40 that is a touch panel.

For example, the driver information registration unit 82 stores the driver's name, account name, and password input by the registered driver in the personalization data storage unit 80. Further, the driver information registration unit 82 stores the face image of the registered driver captured by the interior camera 51 in the personalization data storage unit 80.

The personalization setting unit 81 performs personalization setting of the driver assistance function for each registered driver who is a driver registered in the driver information registration unit 82. For example, when the registered driver performs an input operation on the center display 40, personalization setting becomes possible.

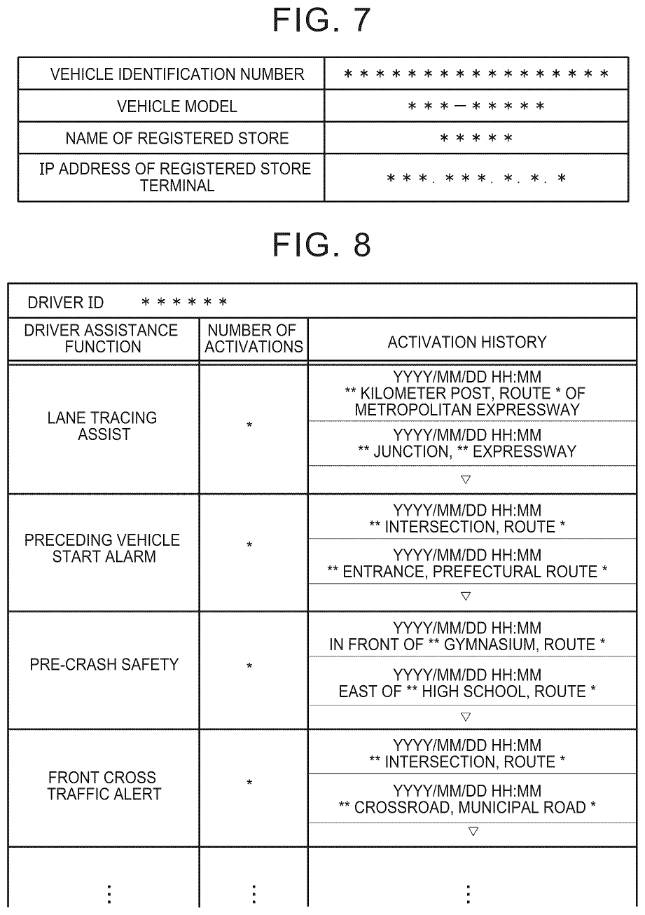

The personalization data storage unit 80 (registered driver data storage unit) stores various data, such as driving history, for each registered driver. For example, the above driver assistance function recording table (see FIG. 8) is stored for each registered driver. Further, the personalization data storage unit 80 also stores the noted action table (see FIG. 9) for each registered driver. Furthermore, the personalization data storage unit 80 stores a vehicle data table exemplified in FIG. 7 as basic data of the vehicle 100. This vehicle data table records vehicle identification numbers, vehicle models, names of the registered stores, and IP addresses of the registered store terminals.

### Registered Store Terminal

The registered store is registered as a main maintenance store for the vehicle 100. For example, the registered store is the store from which the user has purchased the vehicle 100. The registered store is set as a store where the service work on the vehicle 100 is possible. The registered store terminal 160 (see FIG. 1) is a terminal device installed at the registered store, and is composed of, for example, a computer.

The registered store terminal 160 can communicate with the OTA center server 150 and the vehicle 100 via communication means such as the Internet 170. Note that the OTA center server 150 and the registered store terminal 160 can wirelessly communicate with the vehicle 100.

The registered store terminal 160 includes a memory 160A, a storage device 160B, a CPU 160C, and a NIC 160D as a hardware configuration. Since the details of the above devices have been described above, descriptions thereof will be omitted.

The CPU 160C of the registered store terminal 160 executes a program stored in the storage device 160B, whereby the functional blocks exemplified in FIG. 10 are configured in the registered store terminal 160. That is, the registered store terminal 160 includes the inventory confirmation unit 161, the service work setting unit 162, an inventory parts storage unit 163, a customer information storage unit 164, and a service work schedule storage unit 165.

The program may be stored in a non-transitory computer-readable storage medium such as a digital versatile disc (DVD), instead of storing the program in the storage device 160B, and the CPU 160C may read and execute the program. Various functional blocks exemplified in FIG. 10 are configured in the registered store terminal 160 by such means as well.

The inventory confirmation unit 161 can confirm the inventory of each part at the registered store with reference to the inventory parts storage unit 163. For example, when the inventory confirmation unit 161 receives an inventory confirmation signal for a device necessary for executing the additional assistance function from the personalization setting unit 81 of the vehicle 100, the inventory confirmation unit 161 acquires a model of the inquired vehicle 100 from the customer information storage unit 164.

Further, the inventory confirmation unit 161 refers to an inventory table (not shown) stored in inventory parts storage unit 163 to confirm whether a device that matches the model of the vehicle 100 is in stock. After that, the inventory confirmation unit 161 transmits a response signal indicating whether the device is in stock to the personalization setting unit 81 (see FIG. 6).

When the registered store has the device for executing the additional assistance function inquired by the personalization setting unit 81, the service work setting unit 162 refers to the service work schedule storage unit 165 and extracts workable date and time. The workable date and time refers to a candidate date and time for carrying out the service work for installing the device on the vehicle 100 at the registered store. The extracted workable date and time is transmitted to the personalization setting unit 81.

### OTA Center Server

With reference to FIG. 1, the OTA center server 150 wirelessly communicates with the vehicle 100, communicates with the I/F-ECU 112 (see FIG. 6) of the vehicle 100, and transmits and receives signals to and from various ECUs of the vehicle 100. Also, the OTA center server 150 can transmit an update program for executing the additional assistance function to the vehicle 100. For example, the OTA center server 150 is installed at a development center for the vehicle 100 or the like.

The OTA center server 150 includes a memory 150A, a storage device 150B, a CPU 150C, and a NIC 150D as a hardware configuration. Since the details of the above devices have been described above, descriptions thereof will be omitted.

The CPU 150C of the OTA center server 150 executes the program stored in the storage device 150B, whereby the functional blocks exemplified in FIG. 10 are configured in the OTA center server 150. That is, the OTA center server 150 includes a driving diagnostic unit 151, an additional function extraction unit 152, and an additional function storage unit 153.

The program may be stored in a non-transitory computer-readable storage medium such as a digital versatile disc (DVD), instead of storing the program in the storage device 150B, and the CPU 150C may read and execute the program. Various functional blocks exemplified in FIG. 10 are configured in the OTA center server 150 by such means as well.

The driving history data of the vehicle 100 is transmitted to the driving diagnostic unit 151 via the transmission-reception unit 85 of the vehicle 100 (see FIG. 6). This driving history data is summarized for each registered driver. The driving diagnostic unit 151 performs driving diagnosis based on the received driving history data.

For example, in the driving diagnosis, the scores for each classification such as handling, acceleration, or deceleration are calculated. In this calculation, a deduction point is obtained based on the number of times of the noted action and the number of executions of the driver assistance function. For example, the driving diagnostic unit 151 obtains the deduction point for the item of handling based on the number of times of sharp steering and the number of times that lane tracing assist is activated. The calculated driving diagnostic result is transmitted to the ADAS-ECU 70 of the vehicle 100.

The additional function extraction unit 152 extracts additional assistance functions that are driver assistance functions that can be newly added for each registered driver based on the driving history. Further, the additional function extraction unit 152 can transmit the extracted information to the display control unit 92 of the AV-ECU 90.

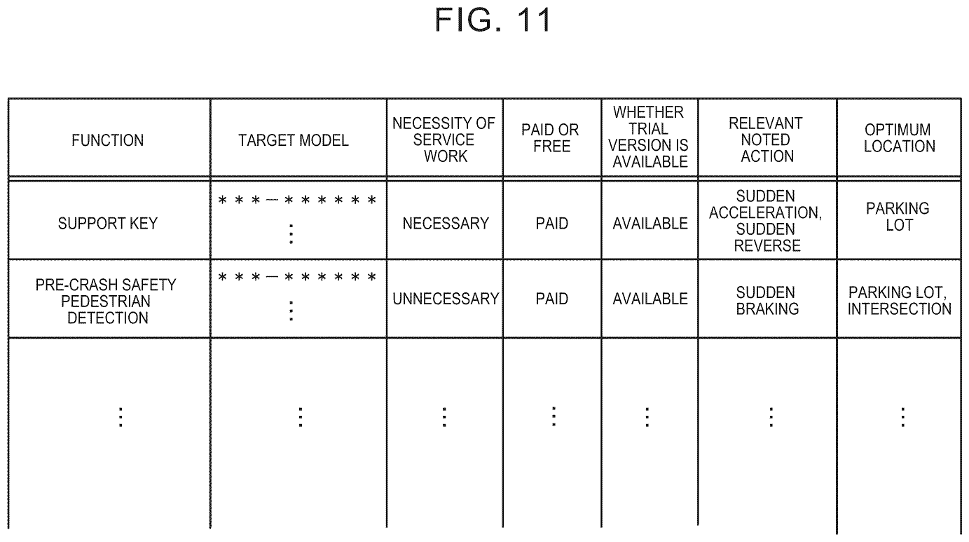

The additional function extraction unit 152 extracts the driver assistance function that can be added to the vehicle 100 with reference to the additional function storage unit 153. For example, the additional function storage unit 153 stores a driver assistance function management table as exemplified in FIG. 11. This table includes items such as the driver assistance functions that can be added, target models, necessity of service work, paid or free, whether a trial version is available, relevant noted actions, and optimum locations.

Basically, the driver assistance function (for example, pre-crash safety) is executed to suppress a certain noted action (for example, sudden braking) in advance. Therefore, in the driver assistance function management table, the noted action as a suppression target are registered as relevant noted actions for each driver assistance function.

Also, a support key in FIG. 11 is a system in which a pedal error suppression function in a parking lot is activated when the registered driver holds the support key. As described above, the optimum location item indicating the location where the driver assistance function is to be activated is provided in the driver assistance function management table.

The additional function extraction unit 152 extracts information on the driver assistance function suitable for the model of the vehicle 100 from the driver assistance function management table stored in the additional function storage unit 153. Further, the additional function extraction unit 152 narrows down the additional assistance function to be additionally proposed based on the driving history of the registered driver. The details of this narrowing down will be described later. The additional function extraction unit 152 transmits information on the narrowed down additional assistance functions to the ADAS-ECU 70 of the vehicle 100.

### Driving Diagnostic Flow

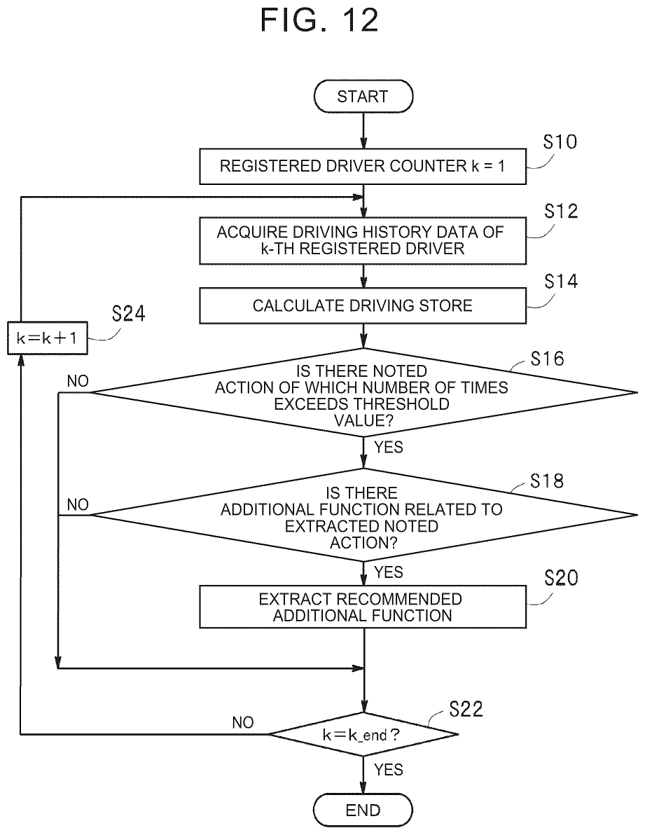

FIG. 12 exemplifies a driving diagnostic flow in the OTA center server 150. With reference to FIGS. 6, 10 and 12, the transmission-reception unit 85 of the ADAS-ECU transmits driving history data for each registered driver stored in the personalization data storage unit 80 to the OTA center server 150. The driving history data includes data of the driver assistance function recording table (see FIG. 8) and the noted action table (FIG. 9) for each registered driver. In addition to the data above, the transmission-reception unit 85 also transmits to the OTA center server 150 the data on the vehicle identification number and the vehicle model in the vehicle data table (see FIG. 7) as the identification information of the host vehicle.

The driving diagnostic unit 151 of the OTA center server 150 sets a registered driver count k to an initial value of 1 (S10). Then, when the driving history data of the k-th registered driver is acquired (S12), the driving diagnostic unit 151 calculates the driving score (S14). The driving score includes a score for each classification such as handling, acceleration, and deceleration as described above, and a total score that integrates the above.

Qualitatively, as the number of the noted actions and the number of executions of the driver assistance functions increase, the driving score becomes lower. Also, as a frequency of occurrences obtained by dividing the number of the noted actions or the number of executions of the driver assistance function by the driving time becomes lower, the score becomes higher.

Next, the additional function extraction unit 152 of the OTA center server 150 extracts the additional assistance functions that are the driver assistance functions that can be newly added to the vehicle 100. The additional function extraction unit 152 determines whether there is a noted action of which number of times exceeds a predetermined threshold value with reference to the noted action table (S16). When there is no such noted action, suggestion of the additional function is omitted (skipped).

On the other hand, when there is a noted action of which number of times exceeds the predetermined threshold value, the additional function extraction unit 152 determines whether there is an additional assistance function related to the noted motion (S18). For example, the driver assistance function management table (see FIG. 11) stored in the additional function storage unit 153 is provided with an item of relevant noted action for each additional assistance function. The additional function extraction unit 152 extracts an additional assistance function (recommended additional function) in which the noted action of which number of times exceeds the predetermined threshold value is included in the relevant noted action (S20).

Next, the additional function extraction unit 152 determines whether the registered driver count k has reached the final value k_end (S22). When the registered driver count k has not reached the final value k_end, the additional function extraction unit 152 increments the count k (S24) and returns the flow to step S12. When the registered driver count k has reached the final value k_end, the flow ends. The driving diagnostic result (that is, the driving score) and information on the recommended additional assistance function obtained in this flow are transmitted to the ADAS-ECU 70 for each registered driver. For example, the driving diagnostic result and the information on the recommended additional function is stored in the personalization data storage unit 80.

### Driving Diagnostic Screen Display Flow

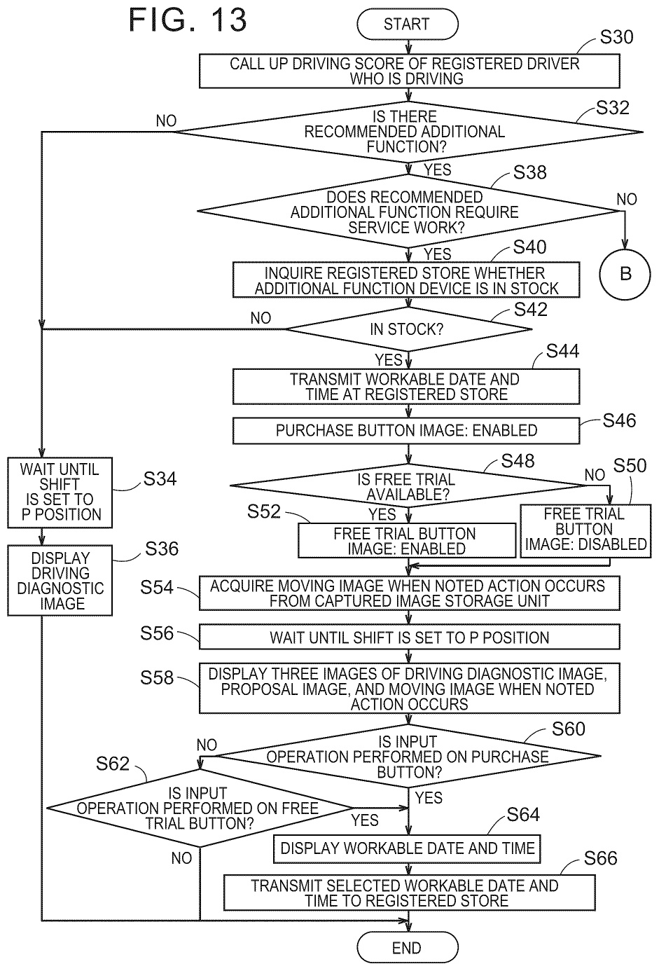

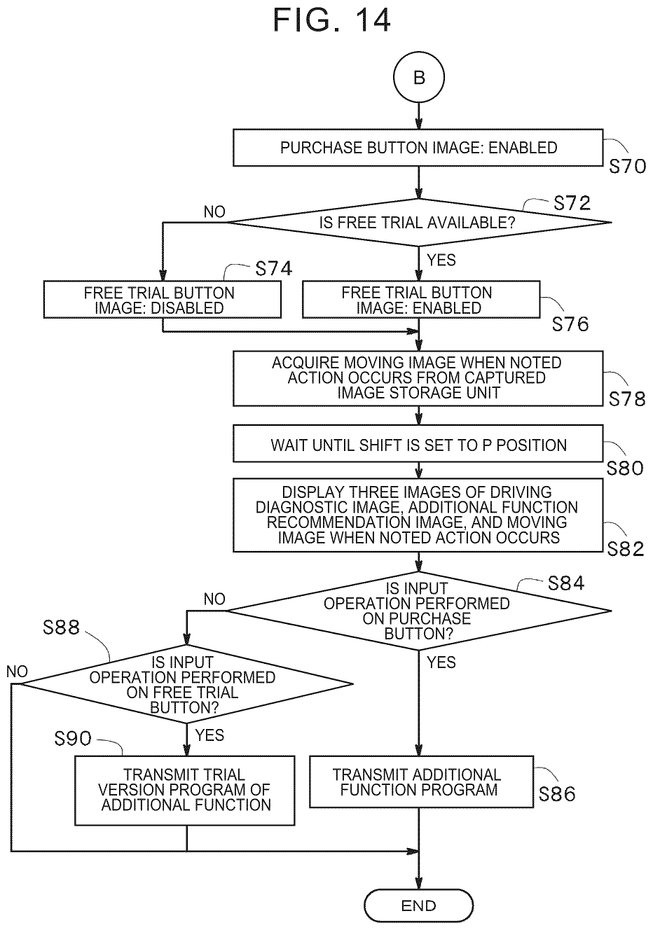

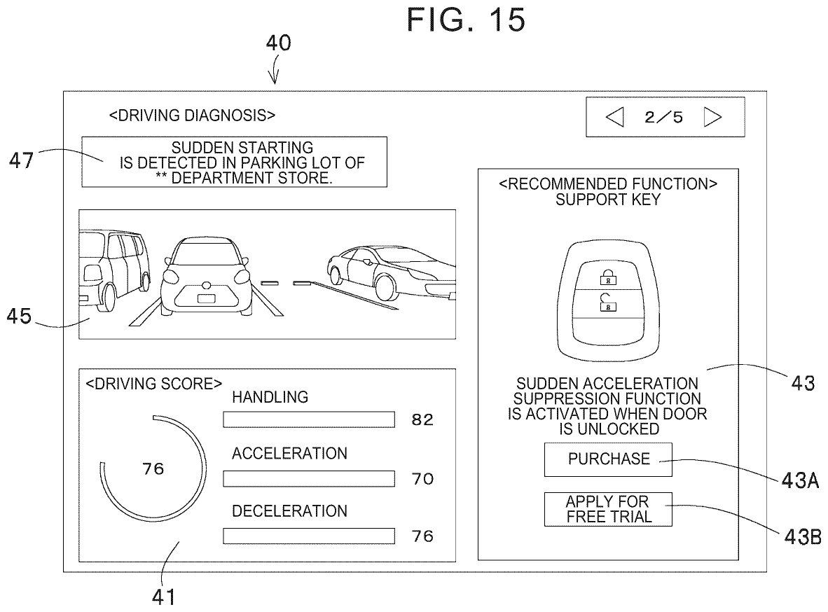

FIGS. 13 and 14 exemplifies the display flow of the driving diagnostic screen by the ADAS-ECU 70 (see FIG. 6) and the registered store terminal 160 (see FIG. With reference to the drawings above, the personalization setting unit 81 calls up the driving diagnostic result of the registered driver who is driving among the driving diagnostic results (driving scores) received from the OTA center server 150 (S30).

Further, the personalization setting unit 81 determines whether information on the recommended additional function is stored in the personalization data storage unit 80 in addition to the driving diagnostic result for the registered driver who is driving (S32).

When the recommended additional function is not set for the registered driver who is driving, only the driving diagnostic image 41 is displayed on the center display 40 among the driving diagnostic image 41, the proposal image 43, and the exterior camera moving image 45 in FIG. 15. The display control unit 92 of the AV-ECU 90 waits for the display of the driving diagnostic image 41 until the shift lever of the vehicle 100 is set to the P position, that is, until the vehicle 100 becomes unable to travel (S34). Then, when the shift lever is set to the P position, the display control unit 92 displays the driving diagnostic image 41 on the center display 40 (S36), and the flow ends.

In step S32, when the recommended additional function information is set for the registered driver who is driving, the personalization setting unit 81 determines whether service work is necessary for executing the recommended additional function (S38).

For example, the recommended additional function information transmitted from the OTA center server 150 includes items such as necessity of installation, paid or free, and whether the trial version is available in the driver assistance function management table (see FIG. 11). The personalization setting unit 81 refers to the above items to determine whether the service work is necessary.

When the setting of the recommended additional function requires service work, the personalization setting unit 81 confirms with the inventory confirmation unit 161 of the registered store terminal 160 (see FIG. 10) via the I/F-ECU 112 whether the device for executing the recommended additional function (hereinafter appropriately referred to as an additional function device) is in stock (S40, S42).

When the registered store does not have the additional function device in stock, the vehicle 100 cannot be equipped with the additional assistance function. Therefore, the display control unit 92 sets the proposal image 43 (see FIG. 15) and the exterior camera moving image 45 that prompts introduction of the recommended additional function to be hidden. That is, the flow proceeds to step S34.

In step S42, when the additional function device is in stock at the registered store, the service work setting unit 162 of the registered store terminal 160 extracts the workable date and time of the additional function device with reference the service work schedule stored in the service work schedule storage unit 165. Further, the service work setting unit 162 transmits information on the extracted workable date and time to the personalization setting unit 81 of the ADAS-ECU 70 (S44).

Upon receipt of the inventory information of the additional function device and the information on the workable date and time, the display control unit 92 of the AV-ECU 90 activates the display of the purchase button image 43A embedded in the proposal image 43 (see FIG. 15) (S46).

Next, the personalization setting unit 81 determines whether a free trial version of the recommended additional function is available with reference to the item of whether the trial version is available in the recommended additional function information transmitted from the OTA center server 150 (S48). When there is no free trial version, the display control unit 92 disables the display of a free trial button image 43B embedded in the proposal image 43 (see FIG. 15) (S50). On the other hand, when there is a free trial version of the recommended additional function, the display control unit 92 enables the display of the free trial button image 43B (S52).

Further, the display control unit 92 displays the condition when the noted action of the driver occurs that is a basis of extracting the recommended additional function by the additional function extraction unit 152 of the OTA center server 150. That is, the display control unit 92 acquires captured moving image data for a time period including the occurrence of the noted action from the captured image storage unit 52 (S54). For example, the noted action table (see FIG. 9) records the date and time when the noted action occurs. The display control unit 92 acquires from the captured image storage unit 52 the moving image data of about 5 seconds before and after and including the occurrence date and time of the noted action.

The display control unit 92 waits to display the driving diagnostic image 41, the proposal image 43, and the exterior camera moving image 45 until the shift lever of the vehicle 100 is set to the P position (S56). Then, when the shift lever is set to the P position, the display control unit 92 displays the three images above on the center display 40, and the flow ends (S58).

Further, the display control unit 92 may cause the center display 40 to display the noted action explanation image 47 in addition to the three images above. For example, the noted action explanation image 47 is a text image explaining what kind of noted action occurs in what place. Such text can be created from the operation history of the noted action table (see FIG. 9).

Further, the display control unit 92 displays the purchase button image 43A and the free trial button image 43B when the process in step S52 is performed in the proposal image 43. When an input operation for acquiring the additional assistance function is received (S60), such as tapping by the registered driver on the purchase button image 43A displayed on the center display 40, the display control unit 92 causes the center display 40 to display the workable date and time received from the service work setting unit 162 of the registered store terminal 160 (S64). Further, the input-output unit 91 of the AV-ECU 90 transmits the workable date and time selected and input by the registered driver to the service work setting unit 162 (S66).

Returning to step S60, when an input operation is not performed on the purchase button image 43A but an input operation is performed on the free trial button image 43B (S62), the flow proceeds to step S64 to adjust the service work schedule. When the input operation is not performed on any of the purchase button image 43A and the free trial button image 43B, the flow ends.

FIG. 14 exemplifies the flow when the service work is determined to be unnecessary in step S38 (see FIG. 13). In this flow, the control program for the additional assistance function is downloaded from the OTA center server 150 to the vehicle 100.

Steps S70 to S82 are the same as steps S46 to S58 (see FIG. 13), and therefore the description thereof is omitted here. In step S84, when the input operation is performed on the purchase button image 43A, the input-output unit 91 (see FIG. 6) requests the OTA center server 150 for the additional function program. In response to this, the OTA center server 150 transmits the additional function program to the ADAS-ECU 70 via the I/F-ECU 112 of the vehicle 100 (S86).

On the other hand, in step S84, when the input operation is not performed on the purchase button image 43A but the input operation is performed on the free trial button image 43B (S88), the input-output unit 91 requests the OTA center server 150 for a trial program of the additional assistance function. In response to this, the OTA center server 150 transmits the trial version program to the ADAS-ECU 70 via the I/F-ECU 112 of the vehicle 100 (S90). When the input operation is not performed on any of the purchase button image 43A and the free trial button image 43B, the flow ends.

### Another Example of Display Unit

In the above-described embodiment, as exemplified in FIG. 15, the center display 40 is exemplified as the display unit that displays the driving diagnostic image 41, the proposal image 43, and the exterior camera moving image 45. However, the driver assistance system according to the present embodiment is not limited to this embodiment. For example, the driving diagnostic image 41, the proposal image 43, and the exterior camera moving image 45 may be displayed on a smartphone owned by the registered driver as a display unit. In this case, the display control unit 92 of the AV-ECU 90 controls the display image of the smartphone that is the display unit.

In this case, the process in step S30 of FIG. 13 is changed to “call up the driving score of the registered driver who is an owner of the smartphone”. Also, on assumption that the smartphone is used outside the vehicle, for example, the contents of processes in steps S56 and S80 in FIGS. 13 and 14 are changed. For example, the processes in these steps are replaced with a process of “waits until the speed detected by the speed sensor of the smartphone that is the display unit reaches zero (0)”.

What is claimed is:

1. A driver assistance system for a vehicle, comprising:
a registration unit that is able to register driver information of the vehicle;
a registered driver data storage unit that stores a driving history for each of registered drivers who are drivers registered in the registration unit;
an additional function extraction unit that extracts an additional assistance function for each of the registered drivers based on the driving history, the additional assistance function being is a driver assistance function that is newly addable; and
a display control unit that is able to output a proposal image that proposes the registered driver an acquisition of the additional assistance function to a display unit.

2. The driver assistance system according to claim 1, wherein the additional function extraction unit is able to transmit, to the display control unit, information on whether a free trial of the additional assistance function is available in addition to information on the additional assistance function.

3. The driver assistance system according to claim 1, further comprising a driving diagnostic unit that performs driving diagnosis based on the driving history, wherein the display control unit causes the display unit to display a driving diagnostic image together with the proposal image.

4. The driver assistance system according to claim 3, wherein:
the registered driver data storage unit stores the number of times of a predetermined noted action from among driver actions for each of the registered drivers; and
the additional function extraction unit extracts the additional assistance function corresponding to the noted action of which number of times exceeds a predetermined threshold value.

5. The driver assistance system according to claim 4, wherein:
the vehicle is provided with an exterior camera that captures an image outside the vehicle, and a captured image storage unit that stores a captured moving image captured by the exterior camera;
the display control unit causes the display unit to display the captured moving image together with the proposal image; and
the captured moving image includes a moving image when the noted action corresponding to the additional assistance function proposed by the proposal image is performed.

6. The driver assistance system according to claim 5, wherein:
when the driver assistance function is executed, an acceleration, a turning attitude, and a braking amount that do not correspond to operation amounts of an accelerator pedal, a steering wheel, and a brake pedal are output from the vehicle;
the noted action includes sudden acceleration, sudden braking, and sharp steering; and
a noted action determination unit that determines whether the sudden acceleration is performed based on the operation amount of the accelerator pedal, determines whether the sudden braking is performed based on the operation amount of the brake pedal, and determines whether the sharp steering is performed based on the operation amount of the steering wheel is provided.

7. The driver assistance system according to claim 6, wherein:
a store that is able to perform service work on the vehicle is registered in the registered driver data storage unit;
an inventory confirmation unit that confirms whether a device for executing the additional assistance function is in stock at the registered store is provided; and
when the device is not in stock at the registered store, the display control unit hides the proposal image.

8. The driver assistance system according to claim 7, further comprising a service work setting unit that extracts a workable date and time when service work of the additional assistance function is able to be performed at the registered store when the device is in stock at the store, wherein in the proposal image, when an input operation for acquiring the additional assistance function is received from the registered driver, the display control unit causes the display unit to display the workable date and time.
